(19) United States
(12) Patent Application Publication
(10) Pub. No.: US 2026/0301473 A1
(43) Pub. Date: Oct. 1, 2026

(54) METHOD FOR COMPUTER PROCESSING OF AN IMAGE SHOWING A FINGERPRINT

(71) Applicant: IDEMIA PUBLIC SECURITY FRANCE, Courbevoie (FR)

(72) Inventor: Jean-Pierre MORICHON, Courbevoie (FR)

(73) Assignee: IDEMIA PUBLIC SECURITY FRANCE, Courbevoie (FR)

(21) Appl. No.: 19/555,027

(22) Filed: Mar. 3, 2026

(30) Foreign Application Priority Data
Mar. 26, 2025 (FR) FR2503108

(51) Int. Cl. G06V 40/60; G06V 10/30; G06V 40/12

(52) U.S. Cl. CPC G06V 40/67; G06V 10/30; G06V 40/1347

(57) ABSTRACT

A method for computer processing of an input image showing a fingerprint, the method including causing a spectral image constituting a Fourier transform of the input image to be displayed on a display screen; detecting user actions while the spectral image is displayed; modifying the spectral image based on the user actions into a modified spectral image; generating an output image constituting an inverse Fourier transform of the modified spectral image; and causing simultaneous display of the modified spectral image and the output image on the display screen.

### DESCRIPTION

### Technical Field

The present invention relates to a method for computer processing of an image showing a fingerprint, and a computer program for implementing this method.

### Prior Art

An image showing a fingerprint is used in various applications. However, such an image may contain noise, making the fingerprint difficult to use in these applications.

The prior art includes software for processing such an image in order to remove the noise it contains, thereby making the fingerprint more visible. The software works in the frequency domain, i.e., it controls the display of a spectral image representing a two-dimensional Fourier transform of the image showing the fingerprint. The software allows a user to apply predefined modifications to the spectral image. The modified spectral image resulting from these modifications is then transformed back into an output image in the spatial domain by applying an inverse Fourier transform. The various modifications applicable in the frequency domain have different effects on the output image. For a given noise to be removed, some modifications will be relevant, while others will not. It is up to the user to identify the most relevant modifications to apply to the spectral image.

However, the software does not allow the user to see in real time the effects in the spatial domain of the modifications they make in the frequency domain. This makes the software particularly tedious to use, especially when the user does not have theoretical knowledge of signal processing that would allow them to easily interpret the meaning of the modifications they apply to the spectral image. As a result, it takes the software user longer to identify the most relevant modifications for removing a given noise.

### DESCRIPTION OF THE INVENTION

One problem to be solved is to enable a user without theoretical knowledge of signal processing to more quickly identify relevant modifications to be made to an image in the frequency domain.

This problem is solved by a method for computer processing an input image showing a fingerprint, the method comprising: causing a spectral image constituting a Fourier transform of the input image to be displayed on a display screen; detecting user actions while the spectral image is displayed; modifying the spectral image based on the user actions into a modified spectral image; generating an output image constituting an inverse Fourier transform of the modified spectral image; and causing simultaneous display of the modified spectral image and the output image on the display screen.

During the proposed method, a user has the ability to simultaneously observe the modified spectral image and the output image in which the modifications applied in the frequency domain are reflected. At a glance, the user can decide whether the modifications applied are suitable for removing the noise they are looking for, without having to perform any additional user actions. As a result, the user can test different modifications more quickly and should normally converge more quickly on an optimal modification than with the software mentioned in the introduction.

The proposed method is a first subject of the invention and may also include the following optional features, taken alone or in combination whenever possible.

Preferably, when the user actions include selecting an area of the spectral image having a height and width respectively less than those of the spectral image, modifying the spectral image includes: identifying a maximum pixel value in the area, and for each pixel in the area, setting the value of the pixel in the spectral image to zero provided that the pixel value is greater than the maximum value multiplied by a threshold.

Preferably, the threshold is adjustable by a user while the spectral image is displayed.

Preferably, selecting the area involves successively selecting two different pixels from the spectral image, the area is rectangular, and the two pixels form two opposite corners of the area.

Preferably, when user actions include selecting the area, modifying the spectral image further includes: calculating a primary deviation between a primary pixel of the selected area and a central pixel of the spectral image associated with a zero spatial frequency, determining at least one secondary pixel of the spectral image that is aligned with the central pixel and the primary pixel, and that is distant from the central pixel by a secondary deviation equal to a multiple of the primary deviation, and for each secondary pixel: determining a secondary area of the same height and width as the selected area, identifying a maximum pixel value in the secondary area, and for each pixel in the secondary area, setting the value of the spectral image pixel to zero provided that the pixel value is greater than the maximum value multiplied by the threshold.

Preferably, when the user actions include selecting in the spectral image a band defined by a direction and by a thickness measured transversely to the direction, modifying the spectral image includes setting to zero the value of each pixel of the spectral image located in the band.

Preferably, at least one of the direction and the thickness is adjustable by a user while the spectral image is displayed.

Preferably, selecting the band includes successively selecting two different pixels of the spectral image, the direction being indicated by a line passing through the two pixels.

Preferably, when the user actions include selecting in the spectral image an angular sector extending from a central pixel of the spectral image associated with a zero spatial frequency, modifying the spectral image includes setting to zero the value of each pixel of the spectral image located within the angular sector.

Preferably, when user actions include selecting in the spectral image a ring extending around a central pixel of the spectral image associated with a zero spatial frequency, the ring being defined by an inner radius associated with a first spatial frequency and by an outer radius associated with a second spatial frequency greater than the first spatial frequency, modifying the spectral image comprises setting to zero the value of each pixel of the image outside the ring, except for the central pixel.

Preferably, at least one of the first spatial frequency and the second spatial frequency is adjustable by a user while the spectral image is displayed.

Preferably, the modification of the spectral image is applied to the initial spectral image, allowing the initial spectral image to be used as a reference for generating a mask, and combining different elementary masks, also facilitating individual cancellations of modifications.

A second proposed object consists of a computer program product comprising program code instructions for executing the steps of the method constituting the first object, when this program is executed by a computer.

### DESCRIPTION OF THE FIGURES

Other features, objectives, and advantages of the invention will become apparent from the following description, which is purely illustrative and non-limiting, and which should be read in conjunction with the accompanying drawings, in which:

FIG. 1 schematically illustrates a computer constituting an image processing device according to one embodiment.

FIG. 2 shows a graphical interface displayed on a display screen, according to one embodiment.

FIG. 3 is a flowchart of the steps of an image processing method according to one embodiment.

FIG. 4 shows a spectral image before applying a modification of a first type according to an embodiment without replication, and FIG. 5 shows a spectral image resulting from the modification of the first type according to this embodiment without replication.

FIG. 6 shows a spectral image before applying a modification of a first type according to an embodiment with replication, and FIG. 7 shows a spectral image resulting from the modification of the first type according to this embodiment with replication.

FIG. 8 shows a spectral image before applying a modification of a second type, and

FIG. 9 shows a spectral image resulting from the modification of the second type.

FIG. 10 shows a spectral image before applying a modification of a third type, and

FIG. 11 shows a spectral image resulting from the modification of the third type.

FIG. 12 shows a spectral image before applying a modification of a fourth type, and

FIG. 13 shows a spectral image resulting from the modification of the fourth type.

FIG. 14, FIG. 15, and FIG. 16 each include a modified spectral image and a corresponding output image showing a fingerprint.

In all of the figures, similar elements are labeled with identical reference signs.

### DETAILED DESCRIPTION OF THE INVENTION

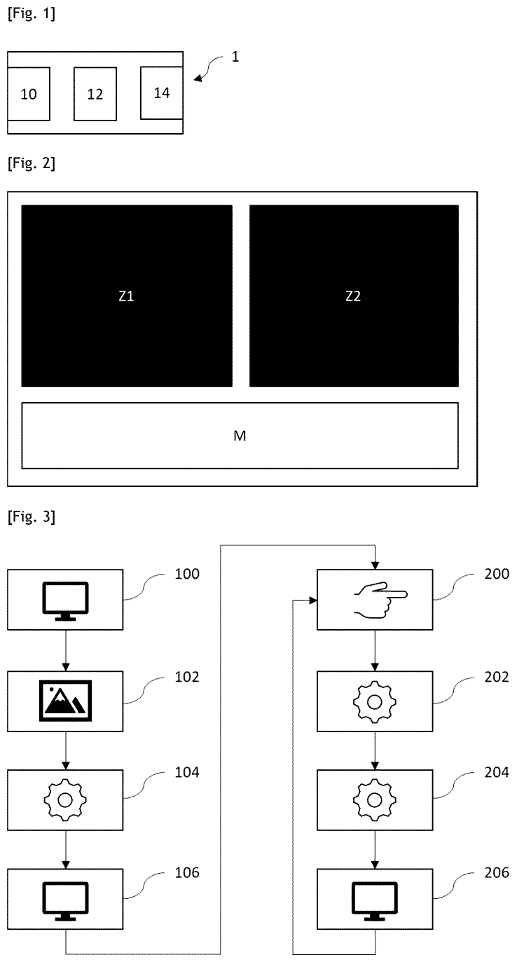

With reference to FIG. 1, a computer comprises an input interface 10, an image processing module 12, and a display screen 14.

The input interface comprises at least one input device 10 capable of receiving user actions, i.e., actions performed by a user. The input interface 10 may comprise at least one of the following input devices for this purpose: a keyboard, a mouse, a touchscreen superimposed on the display screen 14.

The image processing module 12 comprises a memory and at least one processor. The or each processor is of any type. It may be a generic processor, such as a CPU, or a processor specialized in image processing (a DSP, for example).

The memory stores an image processing program comprising code instructions for executing a processing method, the steps of which will be described below, when the program is executed by the processor or processors.

In particular, the program includes code instructions for displaying a graphical interface on the display screen 14.

With reference to FIG. 2, the graphical interface comprises three areas in one embodiment: a first area Z1 capable of containing an image in the spatial domain, a second area Z2 capable of containing a spectral image Z2, and a menu M comprising a number of items for modifying certain parameters of the program.

The processing program is also capable of detecting user actions received by the input interface 10.

With reference to FIG. 3, a method implemented by the program, when the program is executed by the or each processor, comprises the following steps.

In a step 100, for example performed automatically when the program is launched from a computer operating system, the program controls the display of menu M on display screen 14. At this stage, no image is displayed in the first area Z1 and in the second area Z2.

In a step 102, the program detects the selection by a user of an input image showing a fingerprint. To make such a selection, the user can click on an appropriate button in menu M, which triggers the opening of a browser in which the user can navigate to select a file corresponding to the input image.

In a step 104, the program applies a Fourier transform to the input image to produce an initial spectral image representing a 2D spectrum of the input image. This transformation is known in the prior art.

In a step 106, the program commands simultaneous display of the input image and the initial spectral image on the display screen 14. More specifically, the input image is displayed in the first area Z1, and the initial spectral image is displayed in the second area Z2. The order in which the input image and the initial spectral image begin to be displayed is arbitrary, provided that both images eventually become visible simultaneously on the display screen. In particular, it may be provided to display the input image before step 104.

Each pixel of the spectral image has a value corresponding to a gray level. This value represents an amplitude of the underlying spectrum. When the pixel has a value of zero, the pixel is black (zero amplitude); when the pixel has a maximum value, the pixel is white.

The program then waits for user actions via the displayed menu M.

In a step 200, the program detects user actions while the initial spectral image is displayed. It will be seen below that user actions can be performed in the second area Z2 (i.e., on the spectral image displayed there) and/or in the menu M. It will be seen below that the program is capable of detecting different types of user actions.

In a step 202, the program modifies the spectral image based on user actions into a modified spectral image. In other words, the modification applied to the spectral image in step 202 depends on the user actions detected by the program in step 200.

Preferably, the program saves a copy of the spectral image in memory before performing this modification, and saves data indicative of the modification performed in step 202. This backup allows a user to ask the program to test different modifications without risk.

In a step 204, the program applies an inverse Fourier transform to the modified spectral image to produce an output image in the spatial domain that is modified relative to the input image. The transform applied during this step is known in the prior art; it is the reciprocal of the Fourier transform applied in step 104.

In a step 206, the program controls simultaneous display of the output image and the modified spectral image on the display screen 14. More specifically, the output image is displayed in the first area Z1, and the modified spectral image is displayed in the second area Z2. The order in which the output image and the modified spectral image begin to be displayed is arbitrary, provided that both images eventually become visible simultaneously on the display screen 14. In particular, it may be provided to display the modified spectral image before step 204.

Steps 200 to 206 may be repeated over time for different detected user actions. Each time, this results in the simultaneous display of a new modified spectral image in the second area Z2 and its resultant in the spatial domain in the first area Z1. These two simultaneous displays allow a user who does not have in-depth theoretical knowledge of signal processing to visually observe the effects of a modification made in the frequency domain in the spatial domain, and to do so very immediately. The user can thus quickly test different spectrum modifications and quickly converge on an output image that meets their needs, without having to master Fourier theory.

In particular, the program allows the user to revert to changes previously made by the program without having to return to them in the order in which they were applied.

Various modifications will now be described that can be applied to a spectral image displayed in the second area Z2 by the program, for different user actions detected in the step 200.

### Processing in a Replicable Area of Limited Dimensions

The first user actions include selecting an area A1 of the spectral image with limited dimensions. Thus, this area A1 has a height and width that are respectively smaller than those of the spectral image. Preferably, the area A1 has a height less than half the height of the spectral image and a width less than the width of the spectral image.

The area A1, for example, is rectangular. To select area A1, the user can point successively at two different pixels in the spectral image as displayed in the second area Z2 (for example, by clicking with the mouse or with a finger on a touchscreen). The detected rectangular area A1 will then be a rectangle with two opposite corners located at the two selected pixels. Alternatively, the width and height of area A1 are predefined, and the user points to a single pixel: the detected rectangular area A1 will then be a rectangle containing the pointed pixel (this pointed pixel is, for example, the center of the rectangle or one of its vertices).

A first button allowing the selection of these two points can be provided in the menu M displayed. Thus, it is only after pressing this first button that the program waits for the selection of the limited-size area A1 in the spectral image.

The selected area A1 comprises contiguous pixels of the spectral image.

When such an area A1 is selected in step 200, the modification performed in step 202 is a modification of a first type comprising the following sub-steps.

The program identifies a maximum pixel value in the selected area A1.

Next, the program calculates the maximum value multiplied by a threshold. The result of this calculation is a reference value.

The threshold has a value within a range from 0 to 1. The threshold can be presented to the user as a percentage of the aforementioned maximum value.

For each pixel in the selected area A1, the program sets the value of that pixel to zero provided that the pixel value is greater than the reference value. Thus, if the value of the pixel in question is not greater than the reference value, the pixel is not modified. Preferably, filtering on the mask can be applied to avoid/limit echo effects in the output image.

In a non-replication embodiment, any pixel located outside the selected area A1 is not modified. The modified spectral image resulting from step 202 is then obtained.

The display of the modified spectral image in step 206 in place of the spectral image will be perceived by the user as a “darkening” of a subset of pixels in the limited-size area A1 that they have selected (those of which the respective values exceed the reference value).

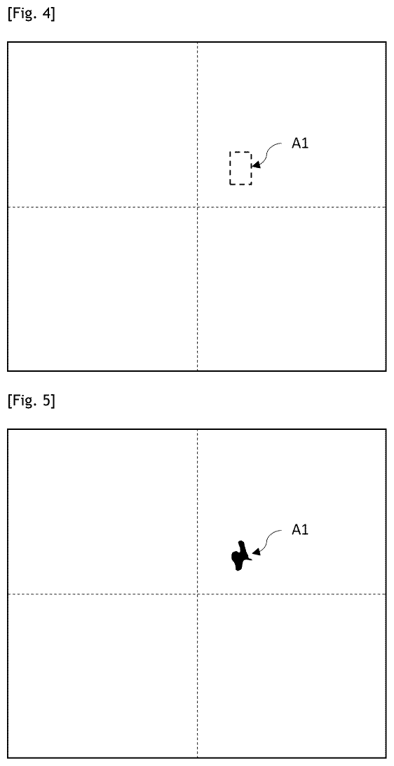

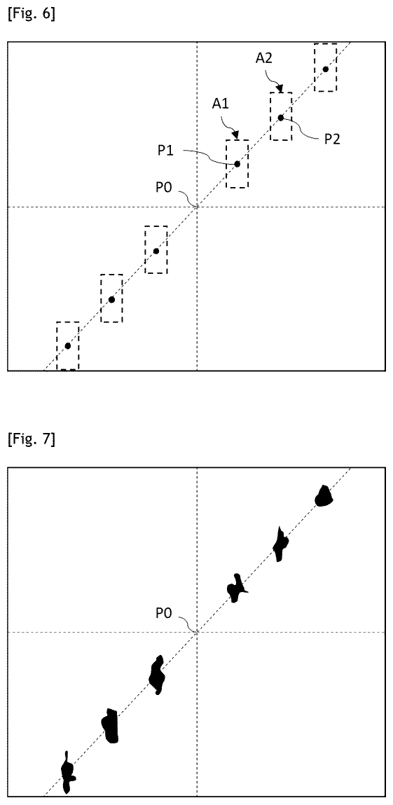

FIG. 4 shows an area A1 of limited dimensions selected by a user, and FIG. 5 shows the result of the first modification applied in area A1. The black part of FIG. 5 refers to all the pixels that have been set to zero by the first type of modification.

In a replication embodiment, the first type of modification (resulting from the first user actions described above) also includes the following additional sub-steps, with reference to FIGS. 6 and 7.

The program determines the coordinates of a primary pixel P0 located in the selected area A1. The primary pixel P1 is, for example, a pixel located at the center of the selected area A1.

The program calculates a primary deviation between the primary pixel P1 and a central pixel P0 of the spectral image associated with a zero spatial frequency (this primary deviation can also be considered a radial distance, since it extends between P0, the center of the spectral image, and P1). In other words, a continuous component is found at this central point P0.

The program determines the coordinates of at least one secondary pixel P2 in the spectral image that satisfies the following cumulative conditions:
the central pixel P0, the primary pixel P1, and the secondary pixel P2 are aligned (which implies that the secondary pixel P2 is distinct from the central pixel P0 and distinct from the primary pixel P1);
the secondary pixel P2 is distant from the central pixel P0 by a secondary distance equal to an integer multiple of the primary distance.

If the primary pixel P1 has polar coordinates comprising an angle and a distance, then the program can simply deduce the polar coordinates of the secondary pixel P2 by proceeding as follows: multiply the distance coordinate of the primary pixel P1 by a positive integer, and retain the angle coordinate of the primary pixel or add 180 degrees to it.

If the primary pixel has Cartesian coordinates (x, y) and if P1 is at the center of the area A1, then the secondary pixel has Cartesian coordinates of the form (kx, ky), where k is a signed integer other than 1 and 0 (to exclude P1 and P0).

It is understood that the number of secondary pixels in the spectral image satisfying the above conditions depends on the location of the area selected by the user in the displayed spectral image. The closer this area is to the center of the image, the greater this number. In the spectral image example shown in FIG. 6, there are the secondary pixel P2 and four other secondary pixels.

Preferably, the program determines the coordinates of all secondary pixels that satisfy the above conditions.

Then, for each secondary pixel, the program determines an associated secondary area that includes the secondary pixel, the secondary area being the same size as the primary area. The secondary area thus has the same width and height as the primary area. It also has the same shape. Thus, when the primary area is rectangular, the secondary area is also rectangular.

The relationship between the primary pixel P1 and the primary area is the same as the relationship between a secondary pixel P2 and its associated secondary area. For example, if the primary pixel P1 is at the center of the primary area, then the secondary pixel P2 is at the center of the associated secondary area.

Next, the changes made in the primary area are repeated in each secondary area. In other words, for each secondary area, the program identifies a maximum pixel value in the secondary area, then, for each pixel in the secondary area, sets the value of the spectral image pixel to zero provided that the pixel value is greater than the maximum value multiplied by the threshold discussed above.

In the replication embodiment, the display of the modified spectral image in step 206 in place of the spectral image will be perceived by the user as a “blackening” not only of a subset of pixels in the primary area that they selected (those of which the respective values exceed the reference value), but also of other pixels in secondary areas aligned with the primary area. The user did not need to manually select these secondary areas in order to darken them. FIG. 7 is an example of the result of this modification applied to the example image in FIG. 6.

Certain periodic patterns appear in a spectral image in the form of aligned lobes. This replication embodiment has the advantage of allowing the user to remove such periodic patterns very easily, i.e., with a very limited number of actions. To do this, the user simply selects a primary area encompassing the primary lobe of the pattern (i.e., the one closest to the center of the spectral image), and the program will find the secondary lobes of the pattern.

It should be noted that the threshold used to zero certain pixels in the selected (primary) area and, where applicable, certain pixels in the secondary area is a parameter that can be adjusted by the user while the initial spectral image is displayed. For example, the menu M may include a slider that can be moved by the user to vary the threshold value between 0 and 1. The value can be presented to the user as a percentage between 0 and 100%.

When the program detects a change in the threshold (this is a user action), the program applies the first type of modification to the initial spectral image, based on the new threshold value.

### Band Processing

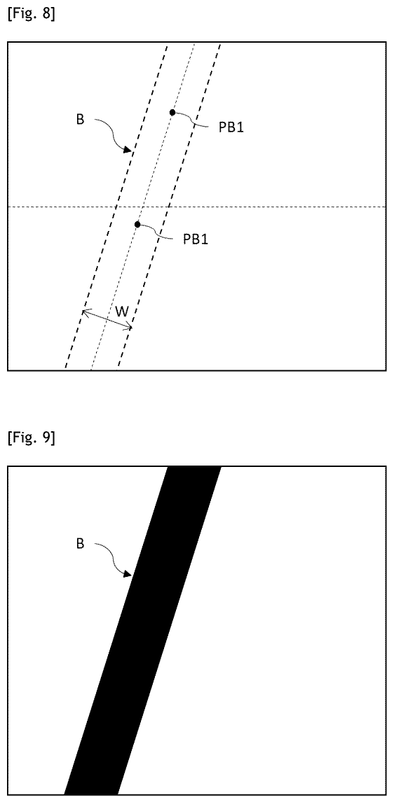

With reference to FIGS. 8 and 9, second user actions include selecting a band B in the spectral image defined by a direction and a thickness W measured transversely to the direction.

Unlike the area of limited dimensions discussed above, the band B has an indefinite length in the direction. In fact, the band is delimited by two lines parallel to the direction, the two lines being separated from each other by the thickness W.

To select the band B, the user can successively select two different pixels PB1, PB2 from the spectral image, the direction being indicated by a line passing through the two pixels PB1, PB2. The line is, for example, a center line of band B, i.e., this line is halfway between the two lines that delimit band B.

A second button allowing band selection may be provided in the menu M displayed. Thus, only after pressing this second button does the program wait for a band to be selected in the spectral image.

When a band B is selected in step 200, the modification performed in step 202 is a second type of modification consisting of setting the values of all pixels located in band B to zero, using a predefined thickness W.

This processing is advantageously applied when the input image shows defects of which the Fourier transform results in lines in the Fourier space.

Preferably, if the band B includes the central pixel P0, then the central pixel P0 is excluded from the band before modification. In other words, the value of the central pixel P0 is, as an exception, not set to zero. It is of interest to retain the zero frequency component (in other words, the continuous component of the input image) because it concentrates a large amount of energy. If the zero frequency component were removed, the output image would be darker than the input image, which is not desirable.

For example, the thickness of the band B can be adjusted using the slider in the menu M.

The pixels of the spectral image outside the band B are not modified.

The thickness W and direction of the band B are parameters that can be adjusted by the user while a spectral image is displayed.

When the program detects a change in the thickness W and/or direction of B (these are user actions), it applies the second type of modification to the initial spectral image, based on the new values of these two parameters.

### Angular Sector Processing

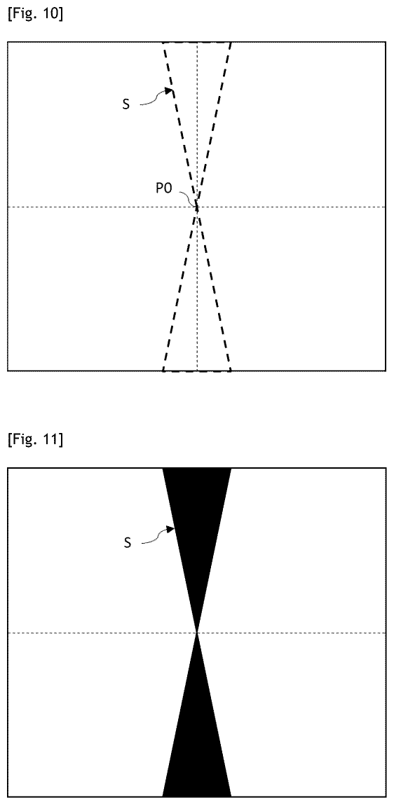

With reference to FIGS. 10 and 11, third user actions include selecting an angular sector S in the spectral image extending from the central pixel P0 of the spectral image (associated with a zero spatial frequency).

Such an angular sector is defined by a main direction of the sector and an angular spread of the sector on either side of the main direction.

To select the main direction, a user can point to a point in the image; the main direction detected will then be a straight line passing through the central pixel P0 and the pointed pixel.

The angular sector is symmetrical with respect to the central pixel P0.

Preferably, the masks used can be defined in only one half of the spectral image and then symmetrized with respect to the central pixel P0. This ensures that symmetry (related to the parity of the Fourier transform of a real signal) is respected.

When an angular sector S is selected in step 200, the modification performed in step 202 is a third type of modification consisting of setting the values of all pixels located in the angular sector S to zero.

Preferably, the central pixel P0 is not part of the angular sector S. The value of the central pixel P0 is then not set to zero for the reasons already mentioned above.

The pixels of the spectral image located outside the angular sector are not modified.

The direction and angular spread of the angular sector are user-adjustable parameters. The user can “rotate” the angular sector around pixel P0 by varying the main direction, and/or can make the angular sector wider or narrower by varying the angular spread. For example, two movable elements can be displayed in the menu M to allow the user to adjust these two parameters independently of each other. These movable elements can be sliders that can be moved by translation or wheels that can be rotated by the user through appropriate user actions. In another embodiment, the menu includes only one movable element to vary the angular spacing, and the user can simply modify the main direction by moving the pixel they have pointed to, using a “drag-and-drop” type action.

This processing is advantageous when a user pursues one of the following goals: removing directional defects, or focusing on certain line directions to better discern the remarkable points of a fingerprint.

A modification of at least one of the angles consists of a user action that triggers a new implementation of a third type of modification of the initial spectral image based on the angle values set by the user.

### Bandpass Filter

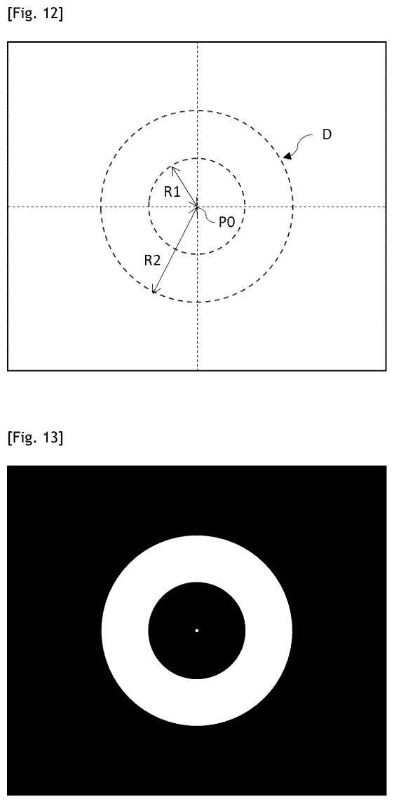

With reference to FIGS. 12 and 13, fourth user actions include selecting a ring D in the spectral image extending around the central pixel of the spectral image (associated with a zero spatial frequency).

The ring D is defined by an inner radius R1 associated with a first minimum spatial frequency and by an outer radius R2 associated with a second spatial frequency. The ring is delimited by two concentric circles: an outer circle having the outer radius, and an inner circle having the inner radius.

When a ring is selected in step 200, then the modification performed in step 202 is a modification of a fourth type consisting of setting to zero the values of all pixels of the spectral image that are located outside ring D, with the exception of the central pixel P0, as shown in the example in FIG. 13.

The modification of the fourth type amounts to retaining the components of the spectral image having the following spatial frequencies: the spatial frequencies that are between the first spatial frequency and the second spatial frequency, as well as the zero frequency. It is of interest to retain the zero frequency component (in other words, the continuous component of the input image) because it concentrates a large amount of energy. If the zero frequency component were removed, the output image would be darker than the input image, which is not desirable.

At least one of the inner radius R1 and the outer radius R2 is a parameter that can be adjusted by a user while the spectral image is displayed. For example, these radii can be adjusted using sliders in the menu M.

This processing is advantageously applied to eliminate all frequency contributions outside a frequency range of an imprint shown in the input image. The default values of R1 and R2 are preselected for this purpose, based on the resolution of the input image. The values of R1 and R2 are selected so as not to damage a fingerprint regardless of the frequency of these lines.

A modification of at least one of the aforementioned radii consists of a user action that triggers a new implementation of the fourth type of modification of the initial spectral image based on the radius values set by the user.

### Other Aspects/Features

The program may include optional steps between step 106 and step 200. These steps are as follows.

The program automatically applies a default modification to the initial spectral image, thereby producing a default modified spectral image, applies an inverse Fourier transform to the default modified spectral image, and causes the default modified spectral image and the default output image to be displayed simultaneously. These steps are similar to steps 202, 204, and 206, but are not triggered by user actions, but automatically after selection of the input image in step 102.

The default modification may be any of the modifications described above.

For example, the default modification is of the fourth type (ring). The program may preselect a default ring R as follows:
determine a peak-to-peak distance between two neighboring peaks of a fingerprint shown in the input image,
obtain a resolution of the input image,
estimate a spatial frequency of the fingerprint from the peak-to-peak distance and the resolution of the input image,
adjust the inner radius R1 so that the first spatial frequency associated with it is strictly less than the spatial frequency of the fingerprint,
adjust the outer radius R2 so that the second spatial frequency associated with it is strictly greater than the spatial frequency of the fingerprint.

This saves user actions while preventing the fingerprint from being completely or partially erased in the corresponding output image.

### Examples of Images Obtained

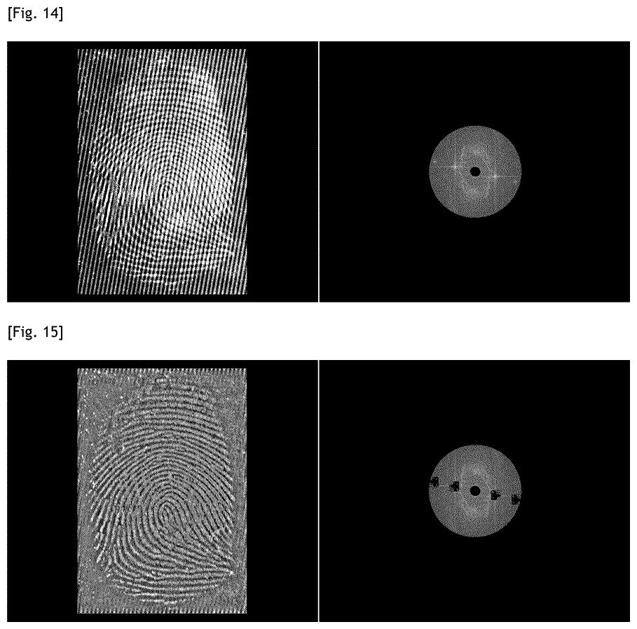

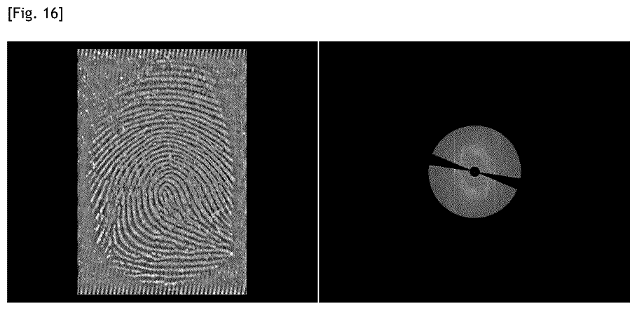

FIGS. 14, 15, and 16 show the results of different processes applied to input images, each showing a fingerprint.

FIG. 14 shows (on the left) an output image resulting from applying the bandpass filter to an input image. This output image shows a fingerprint, but has oblique parallel lines forming a periodic pattern that interferes with the observation of the fingerprint. This periodic pattern is caused by the four lobes visible in the spectral image (right) in the form of four bright spots aligned with the central pixel of this spectral image. It is typical in such a situation that the replicable area processing described above is advantageously applied.

FIG. 15 shows an output image resulting from the cumulative application of a bandpass filter and replicable area processing. A user selected one of the primary lobes, leading to the removal of values in the areas corresponding to the four lobes mentioned above. This made it possible to eliminate the periodic pattern that was visible on the left side of FIG. 14 from the output image.

FIG. 16 shows an output image resulting from the cumulative application of a bandpass filter and angular sector processing. This alternative solution also made it possible to eliminate the periodic pattern that was visible in FIG. 14 from the output image.

1. A method for computer processing of an input image showing a fingerprint, the method comprising:
causing a spectral image constituting a Fourier transform of the input image to be displayed on a display screen;
detecting user actions while the spectral image is displayed,
modifying the spectral image based on the user actions into a modified spectral image,
generating an output image constituting an inverse Fourier transform of the modified spectral image,
causing simultaneous display of the modified spectral image and the output image on the display screen.

2. The method as claimed in claim 1, wherein, when the user actions include selecting an area of the spectral image having a height and width respectively smaller than those of the spectral image, modifying the spectral image comprises:
identifying a maximum pixel value in the area,
for each pixel in the area, setting the pixel value of the spectral image to zero provided that the pixel value is greater than the maximum value multiplied by a threshold.

3. The method as claimed in claim 2, wherein selecting the area comprises successively selecting two different pixels of the spectral image, the area is rectangular, and the two pixels form two opposite vertices of the area, wherein, when the user actions include selecting the area modifying the spectral image further comprises:
calculating a primary deviation between a primary pixel of the selected area and a central pixel of the spectral image associated with a zero spatial frequency,
determining at least one secondary pixel of the spectral image that is aligned with the central pixel and the primary pixel, and that is distant from the central pixel by a secondary distance equal to a multiple of the primary distance,
for each secondary pixel;
determining a secondary area of the same height and width as the selected area,
identifying a maximum pixel value in the secondary area,
for each pixel in the secondary area setting the value of the spectral image pixel to zero provided that the pixel value is greater than the maximum value multiplied by the threshold.

5. The method as claimed in claim 1, wherein when the user actions include selecting in the spectral image a band defined by a direction and by a thickness measured transversely to the direction, modifying the spectral image includes setting to zero the value of each pixel of the spectral image lying within the band.

6. The method as claimed in claim 5, wherein at least one of the direction and the thickness is adjustable by a user while the spectral image is displayed.

7. The method as claimed in claim 5, wherein the selection of the band comprises a successive selection of two different pixels of the spectral image, the direction being indicated by a line passing through the two pixels.

8. The method as claimed in claim 1, wherein, when the user actions include selecting in the spectral image an angular sector extending from a central pixel of the spectral image associated with a zero spatial frequency, modifying the spectral image includes setting to zero the value of each pixel of the spectral image lying within the angular sector.

9. The method as claimed in claim 1, wherein, when the user actions include selecting in the spectral image a ring extending around a central pixel of the spectral image associated with a zero spatial frequency, the ring being defined by an inner radius associated with a first spatial frequency and by an outer radius associated with a second spatial frequency greater than the first spatial frequency, modifying the spectral image comprises setting to zero the value of each pixel of the image outside the ring, with the exception of the central pixel.

10. A computer program product comprising program code instructions for executing the steps of the method as claimed in claim 1, when said program is executed by a computer.
